(19) United States
(12) Patent Application Publication
(10) Pub. No.: US 2008/0166524 A1
(43) Pub. Date: Jul. 10, 2008

(54) Thermoformed cushioning material and method of making

(75) Inventors: Joseph Skaja, Tuscon, AZ (US); Daniel M. Wyner, North Scituate, RI (US); Richard B. Fox, Smithfield, RI (US); Jack Waksman, Easton, MA (US)

Correspondence Address: BOWDITCH & DEWEY, LLP, 311 MAIN STREET, P.O. BOX 15156, WORCESTER, MA, 01615-0156, US

(73) Assignee: Polyworks, Inc., Lincoln, RI (US)

(21) Appl. No.: 11/968,594

(22) Filed: Jan. 2, 2008

Related U.S. Application Data
(60) Provisional application No. 60/883,122, filed on Jan. 2, 2007.
(60) Provisional application No. 60/889,610, filed on Feb. 13, 2007.
(60) Provisional application No. 60/883,123, filed on Jan. 2, 2007.
(60) Provisional application No. 60/889,618, filed on Feb. 13, 2007.
(60) Provisional application No. 60/883,118, filed on Jan. 2, 2007.
(60) Provisional application No. 60/889,628, filed on Feb. 13, 2007.
(60) Provisional application No. 60/913,825, filed on Apr. 25, 2007.
(60) Provisional application No. 60/883,309, filed on Jan. 3, 2007.
(60) Provisional application No. 60/889,634, filed on Feb. 13, 2007.

(51) Int. Cl. B32B 3/00; B28B 1/14

(52) U.S. Cl. 428/166; 264/299; 264/210.1

(57) ABSTRACT

A thermoformed cushioning material, a method of making and products formed with the cushioning material are provided herein.

### RELATED CASES

Priority is hereby claimed to U.S. Provisional patent application Nos. 60/883,122, filed on Jan. 2, 2007; 60/883,123 filed on Jan. 2, 2007; 60/883,118, filed on Jan. 2, 2007; 60/883,309, filed on Jan. 3, 2007; 60/889,610 filed on Feb. 13, 2007; 60/889,618 filed on Feb. 13, 2007; 60/889,628 filed on Feb. 13, 2007; 60/889,634 filed on Feb. 13, 2007; 60/913,825 filed on Apr. 25, 2007; each of which is hereby incorporated by reference in its entirety.

### TECHNICAL FIELD

The present disclosure relates to cushioning materials, methods of making, and articles formed thereby, and in particular, to thermoformed cushioning materials, methods of making, and articles formed thereby

### BACKGROUND

Many different types of products benefit from the inclusion of a material that provides cushioning for, among other things, impact and vibration dampening, resistance to compression, deflection, and the like. One common type of cushioning material that is presently used in a wide variety of applications is open cell foam. The open cells of such foams can trap debris and moisture, thereby supporting the growth of microorganisms such as bacteria and fungi. Therefore, although open cell foams are capable of providing sufficient cushioning for many applications, the tendency to support the growth of bacteria and fungi make it less desirable for body-contacting applications such as sports protective padding, helmet linings, medical pads and braces, seating, and the like. In addition, depending upon the application, it may be necessary to use relatively thick and/or dense open cell foams in order to achieve the desired level of cushioning. As the thickness and/or density of the foam increases, so does the weight, thereby further limiting the applications for open cell foam as a cushioning material.

A relatively lightweight, non-cellular cushioning material is needed in the art.

### SUMMARY

The present disclosure is directed to, in one embodiment, a sheet of cushioning material. The sheet of cushioning material comprises a first layer comprising a polymeric material. The first layer comprises an upper surface and a lower surface. A plurality of resiliently deformable spaced apart cushioning elements are disposed in the polymeric layer. The cushioning elements comprise a sidewall extending upwardly from the polymeric layer to an upper surface, and an interior chamber defined by the sidewall and the upper surface.

In another embodiment, the cushioning material can comprise a second sheet of cushioning material disposed adjacent to the first sheet of cushioning material, wherein the first and second sheets are disposed such that the upper surface of the cushioning elements of the first sheet are substantially aligned with the spaced regions of the second sheet.

In another embodiment, the cushioning material can comprise a second sheet of cushioning material disposed adjacent to the first sheet of cushioning material, wherein the first and second sheets are disposed such that the upper surface of the cushioning elements of the first sheet are substantially aligned with the upper surface of the second sheet.

In any of the foregoing embodiments, one or more of the sheets of cushioning material can comprise at least one active agent.

In any of the foregoing embodiments, upon application of a force to the cushioning material, the cushioning elements deform from an initial shape in a direction substantially perpendicular to the first layer, and upon release of the force, the cushioning elements return to the initial shape.

Another embodiment is directed to a continuous method of thermoforming a cushioning material. The method comprises introducing a first continuous source of polymeric material into a thermoformer, heating the polymeric material, and molding a plurality of resiliently deformable cushioning elements disposed in the polymeric material. The cushioning elements define an interior chamber comprising an upper region spaced apart from the polymeric layer and a sidewall extending upwardly from the polymeric layer to the upper region.

The above described and other features are exemplified by the following figures and detailed description.

### BRIEF DESCRIPTION OF THE DRAWINGS

Referring now to the figures, which are exemplary embodiments, and wherein like elements are numbered alike:

FIG. 1 is a perspective view of one embodiment of a cushioning material in accordance with the present disclosure;

FIG. 2 is a cross-sectional schematic view of the cushioning material of FIG. 1;

FIG. 3 is a perspective view of another embodiment of a cushioning material in accordance with the present disclosure, including a concave depression disposed in the upper surface of the cushioning elements;

FIG. 4 is a perspective view of another embodiment of a cushioning material in accordance with the present disclosure, including inwardly protruding reinforcing ribs disposed in the sidewalls of the cushioning elements;

FIG. 5 is an expanded cross-sectional schematic view of another embodiment of a cushioning material in accordance with the present disclosure, with a multi-layer construction;

FIG. 6 is a cross-sectional schematic view of another embodiment of a cushioning material in accordance with the present disclosure, comprising a stacked arrangement of two sheets of cushioning material with similar geometries and different thicknesses;

FIG. 7 is a cross-sectional schematic view of another embodiment of a cushioning material in accordance with the present disclosure, comprising a nested arrangement of three sheets of cushioning material with similar geometries, different widths and different thicknesses;

FIG. 8 is a cross-sectional schematic view of another embodiment of a cushioning material in accordance with the present disclosure, comprising a nested arrangement of three sheets of cushioning material with similar geometries of successively decreasing width;

FIG. 9 is a cross-sectional schematic view of a helmet comprising a sheet of contoured, non-planar cushioning material disposed adjacent to the inner surface of the helmet;

FIG. 10 is a cross-sectional schematic view of the helmet shown in FIG. 9, comprising a stacked arrangement of two sheets of contoured, non-planar cushioning material disposed adjacent to the inner surface of the helmet;

FIG. 11 is a cross-sectional schematic view of the helmet of FIG. 9, comprising a nested arrangement of two sheets of contoured, non-planar cushioning material disposed adjacent to the inner surface of the helmet; and

FIG. 12 is a schematic of a forming process in accordance with an aspect of the present disclosure.

### DETAILED DESCRIPTION

At the outset of the detailed description, it should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Similarly, the terms “bottom” and “top” are used herein, unless otherwise noted, merely for convenience of description, and are not limited to any one position or spatial orientation. In addition, the modifier “about” used in connection with a quantity is inclusive of the stated value and has the meaning dictated by the context (e.g., includes the degree of error associated with measurement of the particular quantity). Unless defined otherwise herein, all percentages herein mean weight percent (“wt. %”). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). The notation “+/−10%” means that the indicated measurement may be from an amount that is minus 10% to an amount that is plus 10% of the stated value. Finally, unless defined otherwise, technical and scientific terms used herein have the same meaning as is commonly understood by one of skill in the art to which this disclosure belongs.

The present disclosure is directed to a cushioning material that is lightweight, comfortable, and provides significantly better shock absorption than many other cushioning materials. The cushioning materials of the present disclosure are well-suited to applications in which other cushioning materials, such as open cell foams, may be unsuitable due to their tendency to trap debris and moisture, and support the growth of microorganisms such as bacteria and fungi. The construction of the present cushioning materials prevents or minimizes moisture retention. In addition, the present cushioning materials can be made breathable, making them significantly more comfortable than many traditional cushioning materials, such as foamed plastics, for uses near the body.

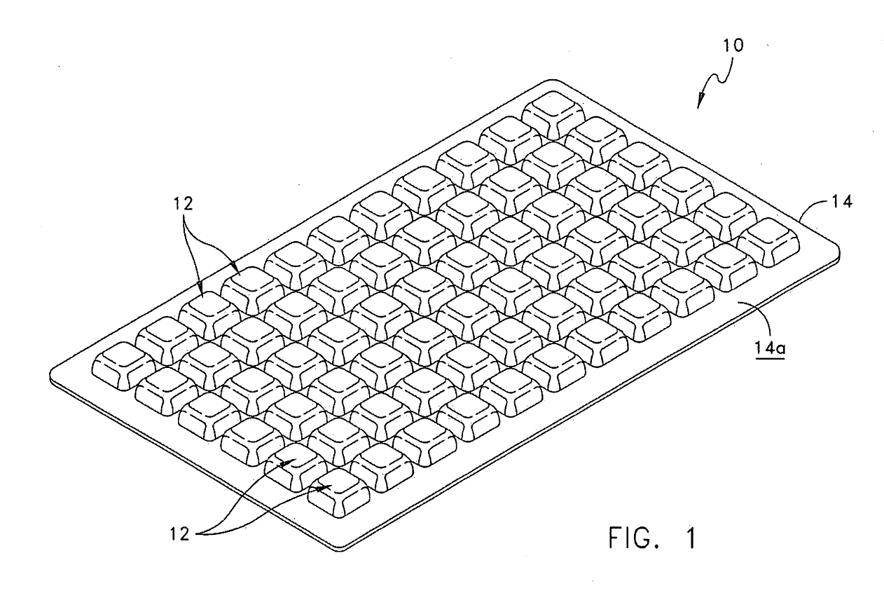

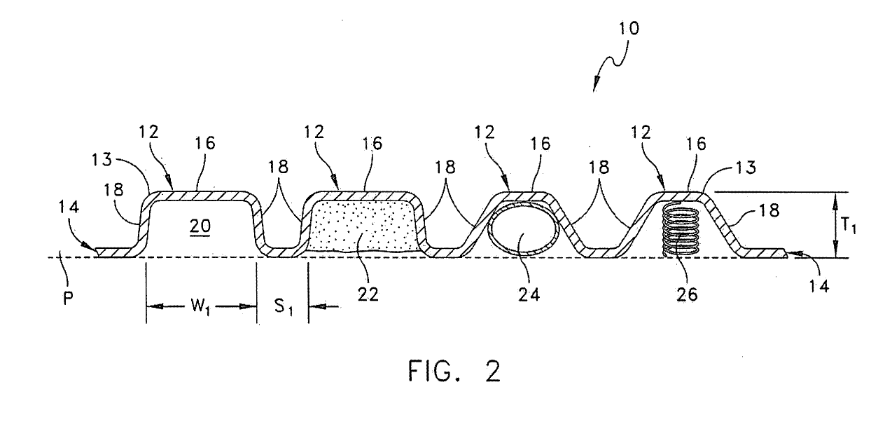

FIGS. 1-2, when taken together, show a sheet of an exemplary thermoformed cushioning material 10 according to the present disclosure. As shown, the sheet of cushioning material 10 comprises a plurality of resiliently deformable cushioning elements 12 disposed in a layer 14. The cushioning elements 12 comprise a thickness T₁, a width W₁, and are spaced apart by a spacing S₁. In the present embodiment, the layer 14 is shown as being substantially coplanar with plane “P”, but it should be understood that layer 14 can non-planar, as well, and that the cushioning elements 12 can be disposed in either a non-planar or substantially planar layer. The sheet of cushioning material 10 can comprise any thickness, which for practical purposes is substantially the same as the thickness of the cushioning elements 12. Cushioning elements 12 can comprise any desired geometry, size and/or orientation; any desired spacing S₁ between regions 12; any desired thickness T₁; any desired width W₁; and any combination of the foregoing. For example, cushioning elements 12 can comprise a round, rectangular or hexagonal shape, and the like, as well as combinations of the foregoing. Cushioning elements 12 can be arranged in any desired pattern or arrangement in layer 14, and cushioning elements 12 of different geometries, size and/or orientations can be combined in order to achieve desired level of cushioning and comfort. In addition, the thickness, durometer and type of material from which layer 14 is formed can be varied. All of the foregoing characteristics can be varied and/or combined in order to provide the desired level of cushioning and comfort in various products.

Each cushioning element 12 comprises an upper surface 16 and a sidewall 18 extending upwardly from layer 14 to the upper surface 16, which together define an interior chamber 20. Upper surface 16 can be disposed substantially parallel to, or at an angle to layer 14, and sidewalls 18 can be disposed substantially perpendicular to or at an angle to layer 14. If desired, the cushioning elements 12 can comprise a radiused edge 13, as shown, which improves the cushioning characteristics of the material.

In any of the foregoing embodiments, if desired, a material and/or a device can be disposed in one or more of the chambers 20 in order to enhance the shock-absorbing characteristics of the cushioning material. Examples of the foregoing materials include, but are not limited to, woven or non-woven fabric, paper, polymeric materials, gels, foamed polymer material, combinations of the foregoing, and the like. Examples of the foregoing devices include, but are not limited to, resilient members such as springs, balloon-type devices filled with air, gel and/or fluid; combinations of the foregoing; and the like. For example, FIG. 2 shows a polymeric gel 22, a gel-filled balloon device 24, and a spring 26, each disposed in one of chambers 20 of cushioning material 10.

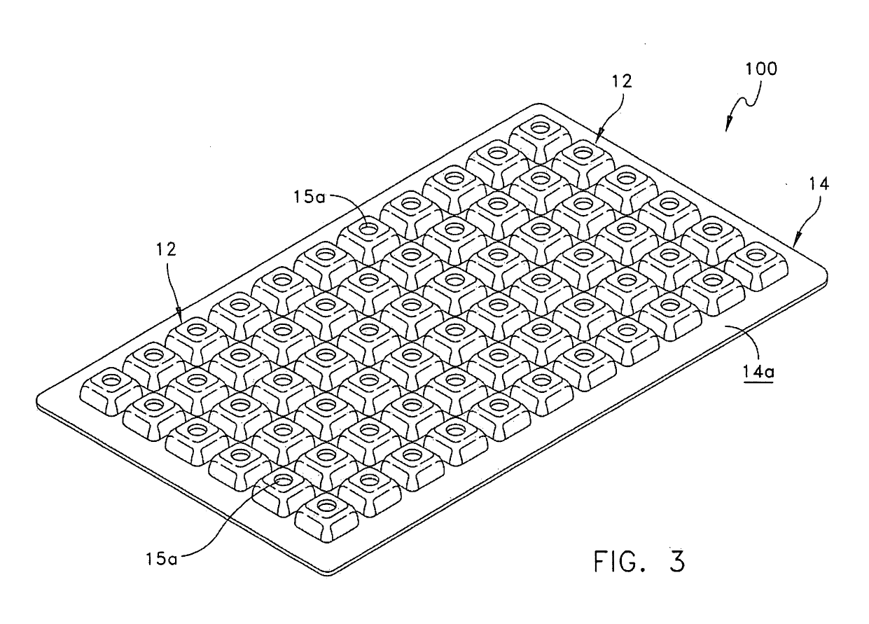

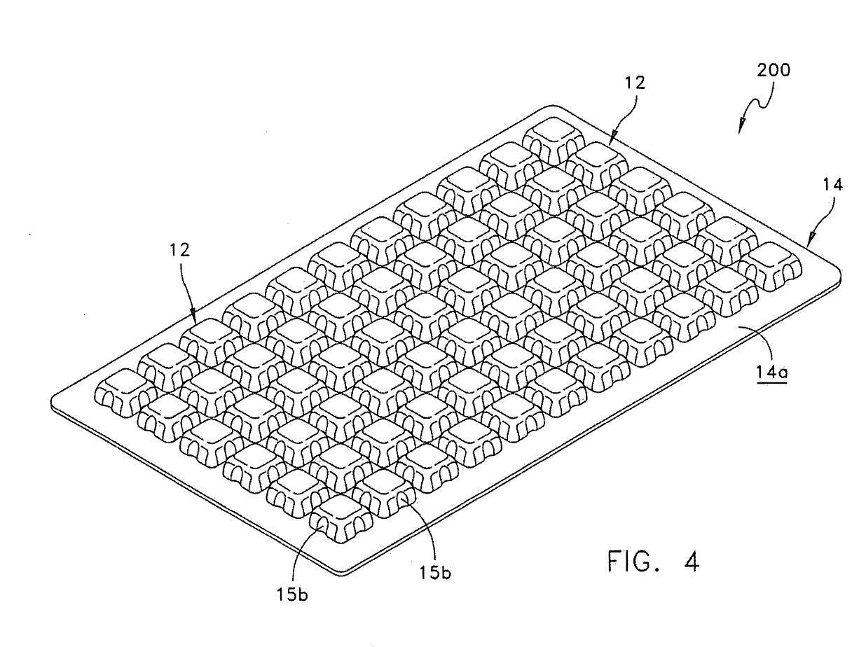

If desired, upper surface 16 and/or sidewalls 18 can comprise one or more reinforcing members 15 disposed therein to increase the force required for deflection of chamber 20 and/or to provide greater stiffness for chamber 20. Reinforcing members 15 can be arranged in any desired pattern or arrangement in cushioning elements 12, and different geometries, size and/or orientations of the reinforcing members can be combined in order to achieve desired level of cushioning and comfort. For example, FIG. 3 shows another embodiment of a cushioning material 100 according to the present disclosure, comprising a depression 15 disposed in the upper surface 16, protruding inwardly toward the chamber 20. Also for example, FIG. 4 shows another embodiment of a cushioning material 200 according to the present disclosure, comprising a plurality of inwardly protruding reinforcing ribs 15 disposed in the sidewalls 18 of cushioning elements 12.

In addition, perforations (not illustrated) can be disposed anywhere in cushioning material 10 in order to provide gas and/or fluid flow through the cushioning material.

Layer 14 can comprise a single material layer or a plurality of material layers, at least one of which comprises a polymeric material layer. The polymeric material can comprise any polymeric material with sufficient structural integrity to be thermoformed (including vacuum assisted thermoforming) into predetermined shapes; sufficient softness and/or pliability to provide comfort against a body; and that is capable of withstanding the environment in which it is intended to be used, without substantial degradation. The polymeric material can comprise a thermosetting polymeric material, a thermoplastic material, including a thermoplastic elastomeric material, and combinations comprising at least one of the foregoing. Some possible materials for the polymeric materials include, but are not limited to, polyurethane, silicone, olefins, vinyl polymers, ether amide, block copolyester, rubber, blends thereof, copolymers thereof, and combinations comprising at least one of the foregoing. Examples of some suitable materials include ethylene vinyl acetate (EVA), Kraton, etc.

The layers of material other than the at least one polymeric material also can comprise a polymeric material, and other materials such as, but not limited to, polymeric materials; knitted, woven or non-woven textiles; fabrics, including spacer fabrics; paper; metallic films; and the like, and combinations comprising at least one of the foregoing. The textile or non-woven layer or layers can be disposed on one or opposite sides of the polymeric material layer. In cases where antimicrobial active is in a surface textile or non-woven layer, it can also be present in the thermoplastic polymer layer beneath the textile or non-woven. If desired, any or all of the foregoing layers can comprise graphics such as logos and/or text printed thereon.

Layer 14 can comprise any thickness suitable for thermoforming, including vacuum assisted thermoforming. In some embodiments, the thickness of layer 14 can range from about 0.005″ (inch) to about 0.120″, more particularly about 0.020″ to about 0.090″, and more particularly still about 0.050″.

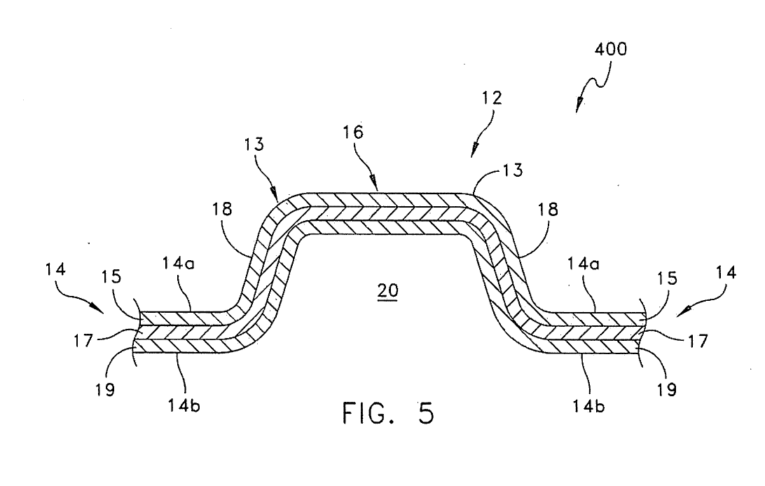

FIG. 5 shows another exemplary embodiment of a cushioning material 400 according to the present disclosure, comprising a layer 14, which in turn comprises one or more material layers 15, 17, 19, at least one of which comprises a polymeric material layer.

Any or all of the foregoing layers can comprise one or more additives such as, but not limited to, modifiers, coloring agents, stabilizers, phase changing materials, ultraviolet inhibitors, and/or active agents as well as combinations comprising at least one of the foregoing. The concentration of the additive can be varied depending on the desired effectiveness of the agent. One possible phase changing material can comprise phase changing microspheres (available under the product name OUTLAST), which contain materials that can change phases at near body temperature. As a result, heat energy can be stored, resulting in a product that can feel cool or warm.

Suitable active agents can comprise tolnaftate, undecenoic acid, allylamines, chlorine, copper, baking soda, sodium omadine, zinc omadine, azoles, silver, and/or the like, and combinations comprising at least one of the foregoing. For example, certain metals such as silver can provide an antifungal/antibacterial effect. For purposes of economy and effectiveness, it has been found advantageous to include active agents, when used, in the exterior layers of the cushioning material because they may come into contact with bacteria, fungus, etc. Disposing the active agents in the exterior surface layers of the cushioning material allows the use of reduced total amounts of the agents to achieve similar effective concentrations in comparison to the inner and/or thicker layers, thereby reducing costs associated with the additives. Also, disposing such agents in the exterior layers ensures that the agents are disposed in the outermost layer of the article i.e., the body contacting regions, rather than in regions remote from the user, which can increase the effectiveness of the agents.

In some instances, it may be desirable to use colorless and/or transparent materials for one or more of the layers, which can be desirable for aesthetic reasons. For example, when it is desirable to include color, graphics and/or text, it can be desirable to use colorless and/or transparent polymeric materials in order to allow the color, graphics and/or text to be visible to a user.

Because the formed structure provides for cushioning through deflection of the cushioning elements rather than by compression of a foamed plastic, rubber or gel, the thickness of the polymer layer in the cushioning material can be significantly less than the thickness used in foamed plastic or rubber to obtain similar impact protection or cushioning. For example, the amount of cushioning obtained from a thermoformed cushioning material 10 formed from a polymeric layer(s) of about 0.060″ can be superior than the amount of cushioning obtained from, for example, a foamed polymeric material having a thickness of 0.5″. In one example, the thickness of the cushioning material 10 may be approximately 0.375″ when measured from the upper surface 16 to the bottom of the polymer layer 14 (i.e. corresponding to T₁), but the actual thickness of the polymer layer 14 at any point in the structure can be the same or less than the starting film thickness. It is for this reason, at least in part, that layer 14 when perforated, mesh, or porous can pass gas and/or liquid more easily than foam structures, particularly thicker foam structures. An open cell foam cushion can breathe, but the air passes through a tortuous path of cells to reach the other side. This tortuous path creates insulation, or dead air space. It also traps moisture.

Air and/or water are unable to pass through the cells of closed-cell foams (e.g., cross-linked polyethylene, and the like). The closed cells in such foams behave more like a sheet of non-porous plastic. One way to allow air and/or water to pass through or “breathe” is to punch or cut holes in the foams, or otherwise perforate the foamed material. Since closed-cell foam products also cushion based on their compression, they are frequently used in thicknesses greater than 0.125″ and up to as much as 1,″ depending upon the application. Due to the thickness of such materials, very small holes tend to collapse and thus minimize or eliminate significant air or moisture movement. For example, if one were to perforate a 0.5″ thickness of cross-linked PE foam with many pin-sized holes, such a perforated foam would still not feel comfortable against the skin, since these holes may not be capable of allowing air and/or water to move through the 0.5″ foam. Holes with a larger diameter (e.g. about 0.125″—the size of an eraser), can be more effective for air and/or moisture movement in these foams. However, perforating the PE foam with many larger holes of such a size can significantly impact its cushioning capabilities, since the foam functions by compression, and a large percentage of the foam surface area may not be able to share the compression load (i.e., the perforated portions). In contrast, the present polymer layer 14 can comprise, for example, a porous open mesh, and can still provide desirable cushioning properties since deflection, rather compression, is used for its cushioning.

If desired, cushioning material 10 can be made porous in order allow the transmission of air and/or fluid from one side of the material to the other. For example, the layer can be made porous by perforating the polymeric layer 14 before or after thermoforming; the polymeric layer 14 can comprise a mesh; or it can be a porous material prior to its thermoforming. As noted above, unlike perforations in closed cell foam structures, the perforations in the polymer layers used in the present materials can be quite small and close together in comparison, while allowing substantial and consistent air and/or moisture movement through the perforations. The polymer layer 14 can also comprise a microporous polymer structure where the pores or holes are sufficiently small to prevent the passage of liquid from a first surface to a second surface, and sufficiently large to allow the passage of a gaseous material (e.g., water vapor), to pass therethrough. In addition, the cushioning material 10 can be constructed from non-porous or porous layers that are also able to transmit moisture by means of a chemical adsorb/desorb process. Such materials include certain thermoplastic polyurethanes, block co-polyesters such as HYTREL, and other moisture transmittable polymers, including moisture transmittable nylon materials (e.g., PEBAX, and the like).

In addition, the use of moisture-breathable or adsorb/desorb polymer layers or porous structures such as perforated, slit, mesh or microporous materials together with the appropriate thermoformed pattern of indentations can create comfort through the ability to move moisture and/or air away from the user. The use of an appropriate textile layer can further be used to control the micro-climate between the cushion component and the user. Because the surface of the present cushioning material is full of indentations, rather than flat, there is the opportunity to in many cases allow for greater airflow when it is positioned in close proximity and/or direct contact with the skin of a user.

Any and all of the foregoing cushioning materials 10 and/or combinations of materials and/or devices can be used to form cushioning materials according to the present disclosure.

If desired, sheets of two or more of the same or different cushioning materials can be combined in a variety of arrangements in order to enhance the cushioning characteristics of a material and/or structure. In this way, the characteristics of the cushioning material can be tailored in products that may have varying cushioning requirements within the same product. Sheets of the same or different cushioning materials can be disposed adjacent to one another in a nested arrangement and/or a stacked substantially planar arrangement. In any of the foregoing embodiments, additional materials and/or devices can be disposed in any or all of the interior chambers in order to further tailor the characteristics of the cushioning material and/or to vary the cushioning and/or resiliency within the material and/or product. Examples of suitable materials include, but are not limited to, those discussed above such as woven or non-woven fabric, paper, polymeric materials, gels, foamed polymer material, combinations of the foregoing, and the like. Examples of suitable devices include, but are not limited to, those discussed above such as resilient members such as springs, balloon-type devices filled with air, gel and/or fluid; combinations of the foregoing; and the like. For example, stacked and/or nested arrangements, a gel and/or a resilient member can be disposed in any or all of the interior chambers of any or all of the sheets of cushioning materials. In addition, the durometer of materials disposed in the interior chambers can be graduated in order to provide varying cushioning characteristics within a cushioning element. The adjacent sheets of cushioning material also can comprise materials with different materials i.e., the durometer of a gel disposed in the interior chamber of an upper sheetcan be softer than the durometer of a material disposed in the interior chamber of a lower sheet.

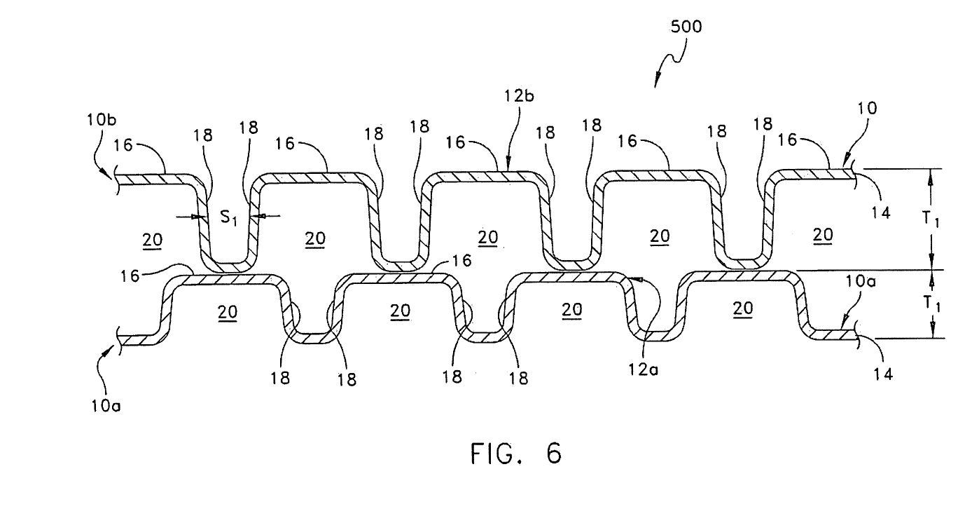

Another embodiment of a cushioning material 500 in accordance with the present disclosure is shown in FIG. 6. As shown, cushioning material 500 comprises a stacked arrangement of two sheets of cushioning material 10a, 10b, in which the cushioning elements 12 of both sheets comprise a substantially square geometry. The upper surface 16a of cushioning elements 12a of the lower sheet of cushioning material 10a are aligned with the space S₁ between the cushioning elements 12b of the adjacent, upper sheet 10b.

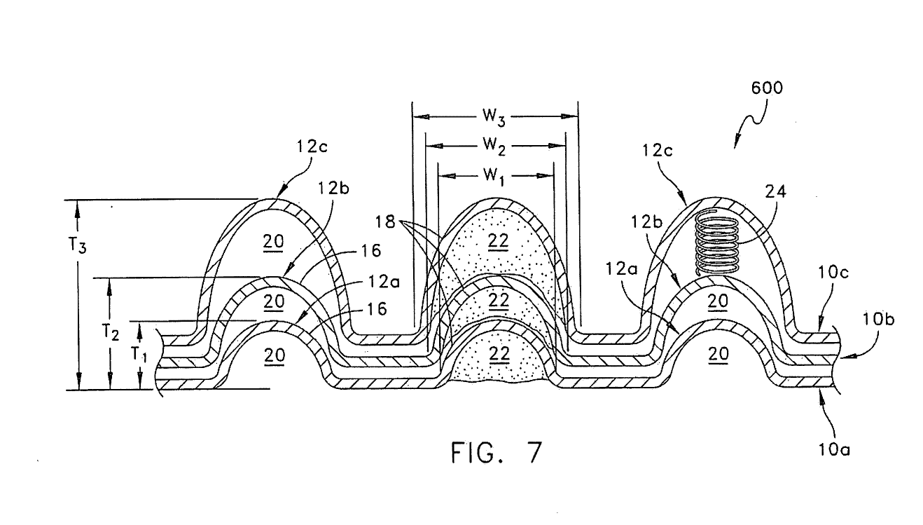

FIG. 7 is a cross-sectional schematic view of another embodiment of a cushioning material 600 in accordance with the present disclosure, comprising a nested arrangement of three sheets of cushioning material 10a, 10b, 10c in which the cushioning elements of both sheets comprise a round geometry. In the present embodiment, the width W₁ of the cushioning elements 12a, 12b, 12c is successively increased in each upper adjacent sheet 10a, 10b, 10c in order to allow the cushioning elements 12a, 12b, 12c to nest, or to be at least partially disposed inside chambers 20 of the next, upper adjacent sheet of cushioning material. Cushioning material 600 also comprises a polymeric gel 22 and a spring 26 disposed in one or more of chambers 20.

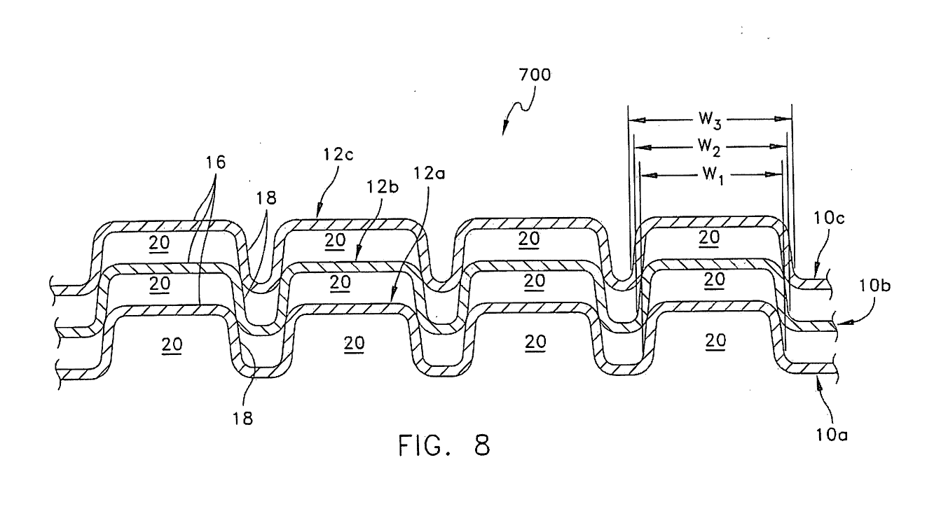

FIG. 8 is a cross-sectional schematic view of another embodiment of a cushioning material 700 in accordance with the present disclosure, comprising a nested arrangement of three sheets of cushioning material 10a, 10b, 10c, in which the cushioning elements 12a,b,c in each cushioning material 10a,b,c comprise a substantially square geometry, in which the width W₁ of the cushioning elements 12 is successively increased in each upper adjacent sheet 10a,b,c in order to allow the cushioning elements 12a,b,c to nest, or to be at least partially disposed inside chambers 20 of the next, upper adjacent sheet of cushioning material.

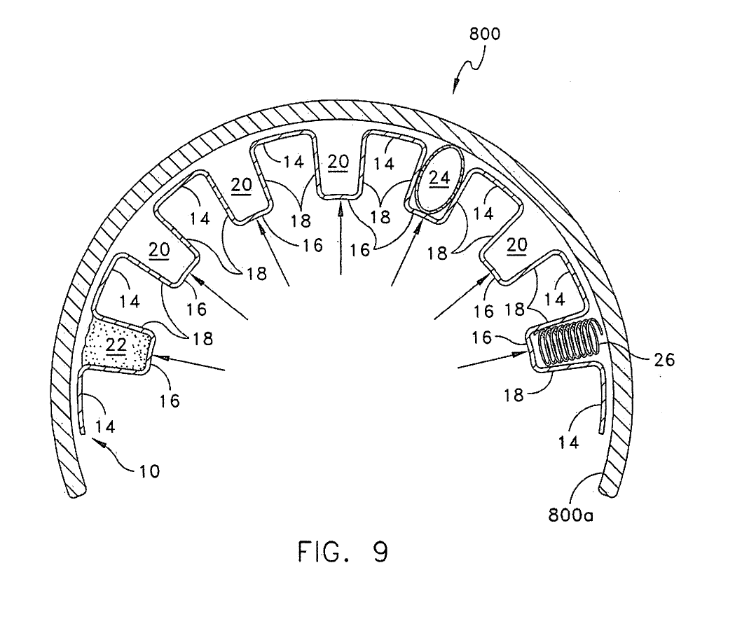

If desired, the foregoing cushioning materials, either as a single sheet or as stacked and/or nested arrangements also can be disposed in a contoured product. For example, FIGS. 9-11 show various embodiments of contoured, non-planar cushioning materials disposed in a contoured article 800, which in this instance is a helmet. As shown in FIG. 9, helmet 800 comprises a contoured or non-planar cushioning material 10 disposed adjacent to the inner surface 800a of the helmet. The cushioning material 10 comprises a plurality of cushioning elements 12 disposed in a contoured or non-planar layer 14, and one or more of chambers 20 comprise a polymeric gel 22, a gel-filled bag 24 and a spring 26.

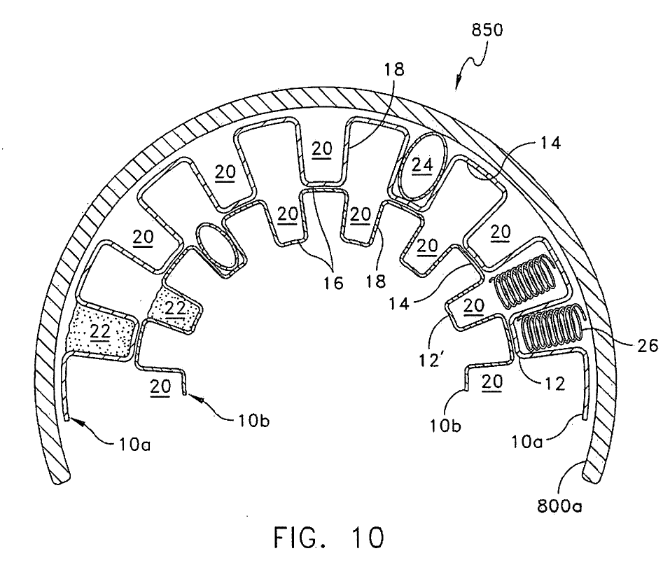

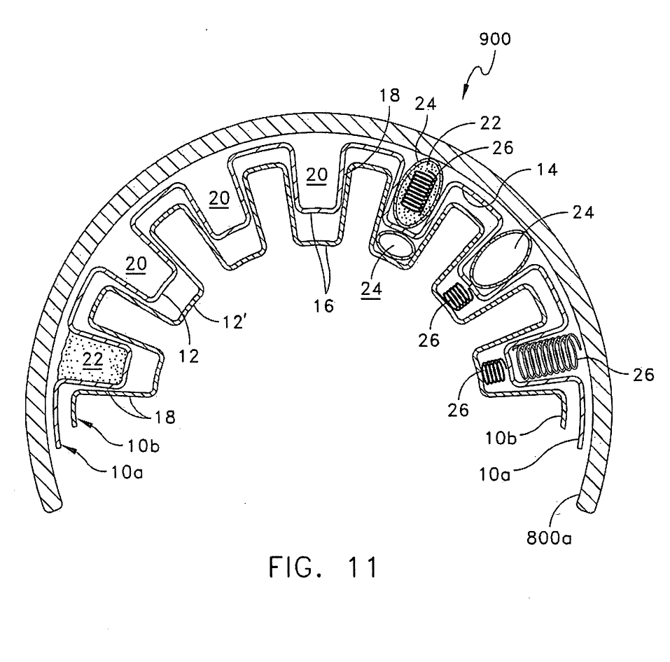

As shown in FIG. 10, helmet 850 comprises a contoured arrangement of two stacked sheets of cushioning material 10a, 10b disposed adjacent to the inner surface 800a of the helmet, in which the cushioning elements 12 of each sheet of cushioning material 10a,b comprise the same geometry (i.e., square), and in which the upper surface 16 of each cushioning element 12a of the sheets 10a, 10b are aligned with the spacing regions S₁ of the adjacent sheet. FIG. 11 shows helmet 900 comprising a nested arrangement of cushioning material 10a,10b disposed adjacent to the inner surface 800a, in which the various cushioning elements 12 of each sheet of cushioning material 10a,b comprise the same geometry (i.e., square), and in which the upper sheet 10b has cushioning elements 12b of larger size than the cushioning elements 12a of the lower sheet 10a (adjacent to the inner helmet surface), such that the smaller cushioning elements 12a are aligned with and nested within the larger cushioning elements 12b of the upper adjacent sheet 10b.

The formation of the cushioned articles of the present disclosure is facilitated by a method for thermoforming involving disposing a sheet of polymeric material between a pair of heated opposing male/female molds, which may be contoured or substantially planar, closing the molds for a sufficient period of time and at a sufficient temperature to allow the polymeric material to conform to the mold, cooling the mold, and removing the thermoformed article. The opposing male/female molds can comprise a substantially contoured pattern, such that the resulting contoured article comprises regions 14 lying in intersecting planes. If more than one layer is used, then the layers can be laminated together prior to molding, or they can be disposed into the mold at the same time as the polymeric layer. If a gas and/or liquid transmissible cushioning material is desired, a gas and/or liquid transmissible material can be used and/or a porous or mesh polymeric layer (and additional layers, if used) can be used. Alternatively, a nonporous material(s) can be thermoformed, and the resulting non-porous cushioning material can be perforated thereafter. If desired or necessary, stretch fabrics can be used in order to provide optimum results in the thermoforming process when introduced prior to thermoforming.

In use, upon the application of a force to the article, the impact will be absorbed by cushioning elements 12, which will deform in a direction that is substantially perpendicular to each of the upper surface 16. Upon release of the force, the cushioning elements 12 will bounce back to their initial shape.

The formation of the cushioning material(s) 10 of the present disclosure is facilitated by a method for thermoforming. As shown in FIG. 11, the method involves disposing one or more continuous sheets of source material 100 into a thermoforming apparatus 950 (hereinafter “press”), at least one of which is a polymeric material. The thermoforming press can comprise a continuous source of polymeric material 28, and a continuous source of one or more additional material(s) 30. The press also can comprise an optional printing station 32, a heating station 34, a forming station 36 (which may be include a vacuum pump 38), and an uptake roller 40 for forming a roll 42 of the thermoformed cushioning material 10. The forming station 36 can comprise a pair of heated opposing male/female forming rollers that have been machined in shape to mold the cushioning elements 12 into the source materials 28,30 on a continuous basis. If desired, the heating station 34 and the forming station 36 may be combined. That is, the forming station 36 may be heated. In use, the continuous sheet(s) 28,30 may be fed into the press 950 on a continuous basis, heated at the heating station 34, and formed into a continuous sheet of cushioning material 10 at the forming station 36, which may be vacuum assisted. After thermoforming, the continuous sheet of cushioning material 10 can be continuously fed onto the uptake roller 40 in order to form a continuous roll of the cushioning material 10. When additional sheets of material 30 are used, they can be disposed into the press 950 simultaneously with the at least one polymeric layer 28, as shown.

In another embodiment, the press can be an indexing press, and may include opposing male/female molds corresponding to the desired cushioning material 10. Thus, in this embodiment, instead of a continuous feed of the source material(s) 28,30, the source material(s) 28,30 can be fed into the press 950 on a start/stop basis. In this manner, a portion of the heated source material(s) 28,30 may reside in the forming station 36 for a sufficient period of time and at a sufficient temperature to allow the source materials to be molded to the desired shape. After thermoforming, the next portion of source material(s) can be indexed into the forming station while drawing additional source material(s) from the rollers and through the optional printing station 32, heating station 34, and into the forming station 36. Optionally, the source materials may be fed into and through an accumulator (not illustrated) that is designed to take up slack in the feed while the press is cycling. Also, optionally, the indexing press molds can be designed to travel with the moving web at the same speed as the web while the thermoforming cycle is taking place. After cycling, the indexing press molds can travel back to their original position in preparation for molding the next section of web.

In another embodiment, the polymeric material 28,30 can be extruded in-line with either the continuous thermoformer or the indexing thermoformer. With in-line extrusion, it is possible to run the process with less heat or possibly no heat since the film will be already be hot as it comes out of the extruder. Because of the reduced heat requirement, the process could in some instances run more rapidly than the methods above wherein the film must be brought to melt temperature in the forming step. In such cases, an accumulator (not illustrated) may be necessary to feed the polymeric film from the extruder to the thermoformer. This will allow the extrusion process to produce film on a continuous basis, while allowing the forming station to cycle.

In either embodiment, one of the sheets of material can be fabric fed into the process prior to or during the forming step, thereby producing a continuous cushioning material incorporating a fabric or multiple fabric layers. In general, the use of fabrics that are stretchable may be advantageous due to the fact that the stretch can accommodate the formation of the indentations/cushioning elements.

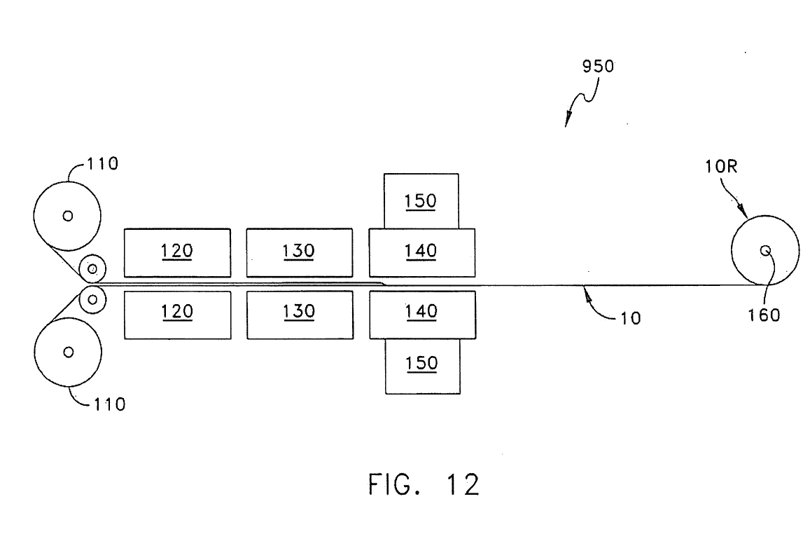

When more than one sheet of material is used, the multiple sheets of material may be fed into press 950 simultaneously with the at least one polymeric sheet, as shown in FIG. 12. If desired, additional continuous sheets of material can be fed into the press at the same time by providing additional continuous sources of material (not illustrated).

Optionally, any of the source materials can be printed i.e., they can comprise color, graphics and/or text printed on one or both surfaces, and more than one sheet of material film may be joined during the process. Optionally, the method can comprise continuously printing one or more layers of the source material prior to feeding into the press, as shown. Alternatively, the source of material(s) can be a source of preprinted material, eliminating the need for the printing station.

In the case of multiple sheets of printed source material, the layers may be disposed such that the printing is disposed between polymeric layers in the finished product, which increases the durability of the printing. Otherwise, printing on a non-exposed side of the finished cushion will be more desirable for durability of the finished product.

Also optionally, any of the source materials can comprise additives, such as antimicrobial active agent, providing a finished cushioning material that is resistant to bacteria or fungi.

Also optionally, any of the source materials can comprise a breathable material such as a perforated or mesh material or a microporous material. Polymer mesh materials are available from a number of sources. Pre-cast films can also be perforated or slit prior to forming. In addition, the finished thermoformed sheet material may be perforated after thermoforming as a subsequent in-line step in the process, or can be perforated off-line as a separate process.

Various textile layers can be introduced into the process as the materials feed into the press. It is often desirable to have a surface layer of textile for aesthetic or comfort reasons, especially when the cushion material will be used against the skin. Unlike flat sheets of foam materials used in other cushioning products, it is somewhat difficult to bond to the convoluted surface of the film after the forming step. Therefore, it is desirable to feed the textile or textiles with the polymeric layer into the press prior to forming. It is possible to bond to the cushion sheet after forming, but fabric bonded in such a manner may not fully conform to the desired shape of the cushioned material 10, and may bridge between the individual cushioning elements 12. Such bridging may be desirable in some cases for aesthetic reasons or to allow better airflow beneath the textile layer.

The same options exist with respect to introducing textiles and antimicrobials in any of the above embodiments. For the in-line extrusion process, printing the film prior to forming would require cooling the film at this point in the process, and this would take away some efficiency. Creating a porous film in the direct extrusion process would most likely involve either perforating as a step subsequent to thermoforming, or in a post process. In addition, moisture transmissible resins could be used in the extrusion process, allowing for a finished product that can transmit moisture vapor without a porous structure.

The present cushioning material is lightweight, comfortable, and can offer significantly better shock absorption than many other cushioning materials. In addition, the cushioning materials of the present disclosure are well-suited to applications in which other cushioning materials, such as open cell foams, may be unsuitable due to their tendency to trap debris and moisture, and support the growth of microorganisms such as bacteria and fungi. The present cushioning material does not retain moisture and can be made to be breathable, making it significantly more comfortable than many traditional cushioning materials, such as foamed plastics, for uses near the body. The present cushioning material does not have a cellular structure and therefore can be more readily laundered without trapping debris and waste products from bodily sweat as is the case with many tradition foam cushion systems, making it ideal for sports protective padding, helmet linings, medical pads and braces and seating applications as well as many other uses. The method of making the material provides an economical, continuous sheet process to produce a shock absorbing cushioning material that is lightweight, and much less susceptible to contamination by sweat than conventional cushioning. The present cushioning materials can comprise fabrics and/or graphics to further enhance the comfort and aesthetics of the material and/or products made from the material.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A sheet of cushioning material, comprising:
a first layer comprising a polymeric material, the first layer comprising an upper surface and a lower surface; and
a plurality of resiliently deformable spaced apart cushioning elements disposed in the polymeric layer, the cushioning elements comprising a sidewall extending upwardly from the polymeric layer to an upper surface, and an interior chamber defined by the sidewall and upper surface.

2. The cushioning material of claim 1, wherein the sheet of cushioning material comprises at least one active agent.

3. The cushioning material of claim 1, further comprising a second layer of material disposed adjacent to upper surface of the first layer.

4. The cushioning material of claim 3, further comprising a third layer of material disposed adjacent to the bottom surface of the first layer.

5. The cushioning material of claim 4, wherein one or more of the second and third layers comprises a polymeric material, and further comprising an active agent disposed in one or more of the second and third layers.

6. The cushioning material of claim 4, wherein one or more of the second and third layers comprises a textile or non-woven material, and further comprising an active agent disposed in one or more of the second and third layers.

7. The cushioning material of claim 1, wherein the active agent is selected from the group consisting of antimicrobial agents, antifungal agents, antiviral agents, and combinations comprising at least one of the foregoing.

8. The cushioning material of claim 5, wherein the active agent is selected from the group consisting of antimicrobial agents, antifungal agents, antiviral agents, and combinations comprising at least one of the foregoing.

9. The cushioning material of claim 6, wherein the active agent is selected from the group consisting of antimicrobial agents, antifungal agents, antiviral agents, and combinations comprising at least one of the foregoing.

10. The cushioning material of claim 7, wherein the active agent is selected from the group consisting of silver, copper, zinc, and combinations comprising at least one of the foregoing.

11. The cushioning material of claim 8, wherein the active agent is selected from the group consisting of silver, copper, zinc, and combinations comprising at least one of the foregoing

12. The cushioning material of claim 9, wherein the active agent is selected from the group consisting of silver, copper, zinc, and combinations comprising at least one of the foregoing.

13. The cushioning material of claim 1, further comprising a resilient material or resilient device disposed in the interior chamber.

14. The cushioning material of claim 1, wherein the cushioning elements comprise a radius edge disposed between the upper surface and the sidewall.

15. The cushioning material of claim 1, wherein the cushioning elements comprise a reinforcing member disposed on one or more of the upper surface and the sidewall.

16. The cushioning material of claim 1, wherein the polymeric material is selected from the group consisting of thermoplastic, thermosetting, elastomeric materials, blends thereof, and combinations comprising at least one of the foregoing.

17. The cushioning material of claim 1, wherein the second layer comprises a spacer fabric.

18. The cushioning material of claim 1, wherein the first layer comprises a moisture transmittable polymer.

19. The cushioning material of claim 1, wherein the first layer is selected from the group consisting of a porous material, an adsorb/desorb material, a mesh material, and combinations comprising at least one of the foregoing.

20. The cushioning material of claim 1, wherein the cushioning material is substantially planar.

21. The cushioning material of claim 1, wherein the cushioning material is substantially non-planar.

22. The cushioning material of claim 1, wherein the cushioning material is porous.

23. The cushioning material of claim 1, wherein the first layer comprises a mesh.

24. The cushioning material of claim 1, wherein upon application of a force to the cushioning material, the cushioning elements deform from an initial shape in a direction substantially perpendicular to the first layer, and upon release of the force, the cushioning elements return to the initial shape.

25. The cushioning material of claim 1, further comprising a second sheet of cushioning material disposed adjacent to the first sheet of cushioning material, and wherein the first and second sheets are disposed such that the upper surface of the cushioning elements of the first sheet are substantially aligned with the spaced regions of the second sheet.

26. The cushioning material of claim 1, further comprising a second sheet of cushioning material disposed adjacent to the first sheet of cushioning material, and wherein the first and second sheets are disposed such that the upper surface of the cushioning elements of the first sheet are substantially aligned with the upper surface of the second sheet.

27. A continuous method of thermoforming a cushioning material, comprising:
introducing a first continuous source of polymeric material into a thermoformer;
heating the polymeric material; and
molding a plurality of resiliently deformable cushioning elements disposed in the polymeric material, the cushioning elements defining an interior chamber comprising an upper region spaced apart from the polymeric layer and a sidewall extending upwardly from the polymeric layer to the upper region.

28. The method of claim 26, further comprising extruding the polymeric material prior to introducing the polymeric material into the thermoformer.

29. The method of claim 26, further comprising introducing the polymeric material into the thermoformer by indexing the polymeric material into the thermoformer.

30. The method of claim 26, further comprising molding the cushioning elements by using mating rollers comprising a mold pattern corresponding to the cushioning elements.

31. The method of claim 26, further comprising molding the cushioning elements by using mating mold sections comprising a mold pattern corresponding to the cushioning elements.

32. The method of claim 26, wherein the cushioning elements comprise a radius edge disposed between the upper region and the sidewall.

33. The method of claim 26, wherein the sidewalls comprise a reinforcing member disposed between the upper region and the polymer layer.

34. The method of claim 32, further comprising disposing a resilient material or resilient device in the chamber.

35. The method of claim 26, wherein the polymeric material is selected from the group consisting of thermoplastic, thermosetting, elastomeric materials, blends thereof, and combinations comprising at least one of the foregoing.

36. The method of claim 26, wherein the polymeric material is selected from the group consisting polyurethane, olefins, vinyls, ether amide, block copolyester, blends thereof, copolymers thereof, and combinations comprising at least one of the foregoing.

37. The method of claim 26, wherein the polymeric material comprises an active agent.

38. The method of claim 36, wherein the active agent is selected from the group consisting of antimicrobial agents, antifungal agents, antiviral agents, and combinations comprising at least one of the foregoing.

39. The method of claim 37, wherein the active agent is selected from the group consisting of silver, copper, zinc, and combinations comprising at least one of the foregoing.

40. The method of claim 26, wherein the polymeric layer comprises a moisture transmissable polymer.

41. The method of claim 39, wherein the polymeric layer is selected from the group consisting of a porous material, an adsorb/desorb material, a mesh material, and combinations comprising at least one of the foregoing.

42. The method of claim 26, further comprising printing a surface of the polymeric layer in a printer after introducing the polymeric material into the thermoformer and before the step of molding.

43. The method of claim 26, further comprising providing a second continuous source of a second material, and introducing the second source of material into the thermoformer simultaneously with the polymeric material.

44. The method of claim 42, further comprising printing a surface of the second material in a printer after introducing the polymeric material into the thermoformer and before the step of molding.

45. The method of claim 42, wherein the second material comprises a textile or nonwoven material.

46. The method of claim 42, wherein the second layer comprises an active agent.

47. The method of claim 45, wherein the active agent is selected from the group consisting of antimicrobial agents, antifungal agents, antiviral agents, and combinations comprising at least one of the foregoing.

48. The method of claim 45, wherein the active agent is selected from the group consisting of silver, copper, zinc, and combinations comprising at least one of the foregoing.

49. The method of claim 42, wherein the second layer comprises a moisture transmissible material.

50. The method of claim 48, wherein the second layer is selected from the group consisting of a porous material, an adsorb/desorb material, a mesh material, and combinations comprising at least one of the foregoing.

51. The method of claim 42, wherein the second material is a polymeric material.

52. A method of molding a cushioning material, comprising:
disposing a layer of polymeric material into a mold;
heating the polymeric material; and
molding a plurality of resiliently deformable cushioning elements in the polymeric material, the cushioning elements defining an interior chamber comprising an upper region spaced apart from the polymeric layer and a sidewall extending upwardly from the polymeric layer to the upper region.
